(19) United States
(12) Patent Application Publication
(10) Pub. No.: US 2015/0260454 A1
(43) Pub. Date: Sep. 17, 2015

(54) ADSORBED WATER REMOVAL FROM TITANIUM POWDERS VIA WATER ACTIVATION

(71) Applicant: UT-BATTELLE LLC, Oak Ridge, TN (US)

(72) Inventor: Thomas R. MUTH, Knoxville, TN (US)

(21) Appl. No.: 14/206,398

(22) Filed: Mar. 12, 2014

(51) Int. Cl. F26B 3/28; F26B 17/00; B22F 1/00

(52) U.S. Cl. CPC F26B 3/283; B22F 1/0085; F26B 17/00

(57) ABSTRACT

A process for the removal of adsorbed water from the surface of powder materials includes the step of flowing a heated gas over the powder. The temperature of the gas is below the cracking temperature of the water. The gas is inert with the powder. An ultraviolet light is applied to the powder at a wavelength that will pass through the gas, heat the adsorbed water and desorb it, and reflect from the powder. The ultraviolet light has a wavelength between 10-185 nm. Water is removed from the powder with the flowing gas.

### STATEMENT REGARDING FEDERALLY SPONSORED RESEARCH

This invention was made with government support under contract No. DE-AC05-00OR22725 awarded by the U.S. Department of Energy. The government has certain rights in this invention.

### FIELD OF THE INVENTION

This invention relates generally to the field of powder metallurgy and more particularly to water removal during powder metallurgy processing.

### BACKGROUND OF THE INVENTION

Adsorbed water on the surface of titanium powders produced in the solid state may be a causal factor in unexplained low biaxial formability in consolidated sheet, unexplained oxygen pick-up and poor weldability in powder metallurgy titanium. Thermal desorption of water vapor on titanium powders has been one of the most commonly used techniques to address the removal of adsorbed water. It has been suggested that if adsorbed water is to be removed by thermal means it should be no higher than 350° C. to avoid H₂O (g) from cracking to become H₂(g) and O₂(g) whereby the O₂(g) reacts with the titanium to form TiO₂.

Some powder work has been performed on Ti-64 atomized powders in an article “Titanium Alloy Powder Preparation for Selective Laser Sintering” from Rapid Prototyping Journal, V6, Issue 2, (2000), p 97-106. The Brunauer, Emmet and Teller (BET) on the powders ranged from 0.046 to 0.067 m²/g. Heating was performed in an actively evacuated quartz tube with a residual gas analyzer (RGA) attached. In those trials a powder with a BET of 0.061 m²/g showed water vapor evolving from 140° C. to 305° C. Hydrogen evolution was detected between 450° C. and 475° C. Powder with an initial surface area of 0.067 m²/g showed maximum hydrogen outgassing between 575° C. and 630° C. It was postulated that the observed hydrogen was from atmospheric contamination. Atmospheric hydrogen does not naturally exist. It is perhaps more likely that the source of hydrogen was adsorbed water beginning to crack into H₂(g) and O₂(g).

There is likely a very narrow temperature window for thermal desorption to occur; where free water is driven off maximally between 250° C. and 300° C., and where adsorbed water closely adhered to the surface of titanium, upon further heating, will decompose to H₂(g) and O₂(g). The H₂(g) will either dissolve according to equilibrium into the titanium solid, form TiH₂ or will eject into the atmosphere surrounding the titanium as H₂(g). The O₂(g) will form TiO₂ on the surface until a temperature of approximately 400° C. is attained, where upon the TiO₂ will dissolve into the metallic solid titanium.

### SUMMARY OF THE INVENTION

A process for the removal of adsorbed water from the surface of powder materials includes the step of flowing a heated gas over the powder. The temperature of the gas is below the cracking temperature of the water. The gas is inert with the powder. An ultraviolet light is applied to the powder at a wavelength that will pass through the gas, heat the adsorbed water and desorb it, and reflect from the powder. The ultraviolet light has a wavelength of between 10-185 nm. The desorbed water is removed from the powder with the flowing gas.

The powder can be at least one selected from the group consisting of ceramics and metals. The powder can be a metal. The metal can be titanium. The metal can be at least one selected from the group consisting of titanium, iron, aluminum, copper, and mixtures thereof.

The temperature of the gas can be less than 300° C. The gas can be at a temperature of 100-300° C. The wavelength of the ultraviolet light can be between 130-160 nm.

The gas can be an inert gas. The gas can be N₂. The absolute pressure of the gas can be greater than 100 torr.

A process for desorbing water from the surface of powdered metals can include the steps of a) flowing a heated gas over the powder, the temperature of the gas being below the cracking temperature of the water, the gas being inert with the powder; b) applying to the powder an ultraviolet light at a wavelength that will pass through the gas, heat the adsorbed water and desorb it, and reflect from the powder, the ultraviolet light having a wavelength of between 10-185 nm; c) removing the water from the powder with the flowing gas; and d) raising the temperature of the powder for a time sufficient to remove the adsorbed water.

An apparatus for the removal of adsorbed water from the surface of metal powders includes a hermetic desorption chamber. A source is provided for applying UV light having a wavelength of between 10-185 nm to a powder within the chamber. A source of an inert gas is provided. The inert gas can be at a temperature of between 100-300° C. The source is connected to the gas inlet of the desorption chamber.

A vacuum pump can be provided for maintaining the pressure within the desorption chamber to as low as 100 torr. The desorption chamber can further include a gas inlet and a gas outlet. The desorption chamber can have a crucible for positioning the powder in the path of the UV light from the light source. The chamber can have a window that is transmissive to the UV light.

### BRIEF DESCRIPTION OF THE DRAWINGS

There are shown in the drawings embodiments that are presently preferred it being understood that the invention is not limited to the arrangements and instrumentalities shown, wherein:

FIG. 1(a)-(c) is a schematic diagram of an apparatus for the desorption of water from powdered materials.

FIG. 2 is a plot of the absorption coefficients of water vapor in the spectral region 1250-1850 Å.

### DETAILED DESCRIPTION OF THE INVENTION

A process for the removal of adsorbed water from the surface of powder materials includes the step of flowing a heated gas over the powder. The temperature of the gas is below the cracking temperature of the water. The gas is inert with the powder at the temperature of the gas. An ultraviolet light is applied to the powder at a wavelength that will pass through the gas, heat the adsorbed water and desorb it, and substantially reflect from the powder. The ultraviolet light has a wavelength between 10-185 nm. The wavelength of the ultraviolet light can more particularly be between 130-160 nm. Water vapor is removed from the powder by the heated flowing gas.

The powder can be at least one selected from the group consisting of ceramics and metals. The metal can be at least one selected from the group consisting of titanium, iron, aluminum, copper, and mixtures thereof.

The gas can be at a flowing temperature of less than 300° C. The 300° C. temperature ceiling avoids detrimental kinetics associated with the formation of TiN and stays below the temperature at which H₂O(g) dissociates on a titanium surface. The gas can be at a temperature of 100-300° C. The gas can be inert to the powder at the flowing temperature, and can be an inert gas such as N₂.

The pressure within the chamber over the powdered material may range from an absolute pressure of 100 torr and higher. The vacuum ultraviolet (VUV) light is applied to the powdered material while the inert gas is flowing over the powdered material.

A process for treating metal powders comprises the steps of flowing a heated gas over the powder, the temperature of the gas being below the cracking temperature of the water. The gas is inert with the powder. An ultraviolet light at a wavelength that will pass through the inert gas is applied to interact with the adsorbed water on the surface of the powder and desorb it and reflect from the powder. The ultraviolet light can have a wavelength of between 10-185 nm. The wavelength of the ultraviolet light can more particularly be between 130-185 nm. Desorbed water is removed from the system in the flowing gas.

The heating of the powder by the flowing gas can precede the application of the ultraviolet light. For example, the heated gas can flow over the powder for any length of time to heat the powder to gas temperature prior to the application of the ultraviolet light. The ultraviolet light can be applied for any length of time dependent on desired removal level of adsorbed water. The power/intensity of the ultraviolet light can be 30 watts or higher.

An apparatus for the removal of adsorbed water from the surface of metal powders includes a hermetic desorption chamber. A source is provided for applying UV light having a wavelength of between 10-185 nm to a powder within the chamber. A source of an inert gas is provided. The inert gas is at a temperature of between 100-300° C. The apparatus can further include a vacuum pump for maintaining a partial pressure below atmospheric pressure if desired within the desorption chamber to keep pressures as low as 100 torr while inert gas is flowing. The desorption chamber can have a gas inlet and a gas outlet and the inert gas source can be connected to the gas inlet. The desorption chamber comprises a container for positioning the powder in the path of the UV light from the light source, and for contacting the powder with the flowing heated inert gas. The apparatus can have a window that is transmissive to the UV light at a wavelength that will heat the adsorbed water to desorb it and transmit through the inert gas.

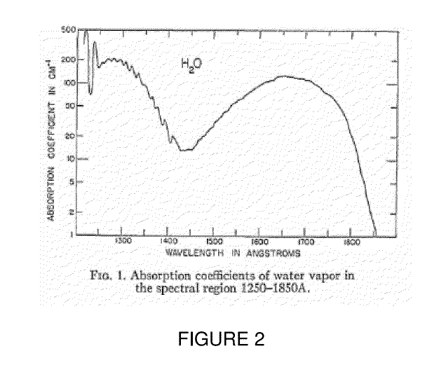

The invention provides improved low energy processing by adding energy in large part only to the adsorbed water to overcome the bonding energy of the water molecule, while leaving the bulk titanium powder at ambient temperature conditions. Water strongly absorbs to the wavelengths below 135 nm and above 155 nm as shown in FIG. 2. Higher wavelengths above 175 nm show a dramatic absorption drop. A VUV source less than 170 nm in wavelength interacts with water vapor adsorbed on the titanium surface to apply the requisite 23 kcal/mole, liberates the H₂O(g), and allows transfer of the vapor into a flowing nitrogen stream.

A source of VUV light can be produced by a microwave generated electrodeless lamp filled with H, Kr or Xe. Other suitable VUV sources are possible. The effectiveness of UV light to enhance water desorption is shown in U.S. Pat. No. 4,660,297 “Desorption of Water Molecules in a Vacuum System Using Ultraviolet Radiation” and elsewhere. Although the wavelengths of 183 and 254 nm are witnessed to desorb water, the water absorption spectra indicates poor absorption in those wavelengths yet water desorption occurred. Shorter wavelengths will result in increasing water desorption as the wavelength shortens.

The light source such as a VUV krypton light source or a xenon light source is selected for the desired wavelength with consideration for the flowing inert gas. Nitrogen or another inert gas is used as the sweep gas to transfer water that has been ejected from the metal surface out of the exposure vessel. Ideally full transparency of nitrogen to the VUV light would be desirable to allow efficient VUV light exposure of the titanium powder surface without interference. The transmission spectrum for nitrogen is somewhat varied in the literature and therefore there is some need to broaden the spectrum for optimization. Multiple light sources can be beneficial but are not necessary.

VUV exposure time intervals can be varied. The powders can be fluidized by the inert gas, such as by 120° C. nitrogen. Analysis of the head space nitrogen during VUV exposure is not necessary but analysis correlating VUV exposure time versus bulk composition of O₂(g)/N₂(g)/H₂(g) will provide the empirical guidance to assess optimum processing conditions.

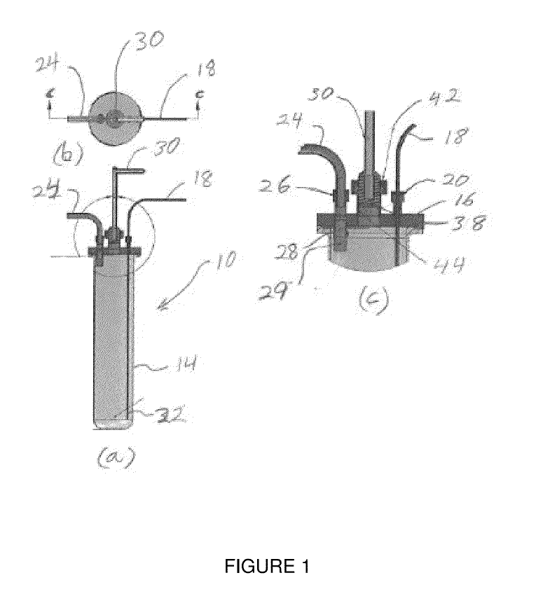

A device for the VUV treatment of powder materials is shown in FIG. 1. The device 10 includes a desorption chamber 14 which can be sealed by a hermetic closure or lid 16. An inert gas inlet 18 supplies inert gas to an outlet 22 within the desorption chamber 14 so as to flow inert gas over powder material in the desorption chamber 14. A vacuum disconnect 20 can be utilized to connect the inert gas inlet 18 to the desorption chamber 14 in a hermetic fashion. An inert gas exhaust conduit 24 is provided for exhausting the inert gas and water vapor from the desorption chamber 14. The exhaust conduit 24 can include quick disconnect 26 and a filter 29 over interior end 28 of the inert gas exhaust conduit 24. A source of ultraviolet light 30 is provided for introducing ultraviolet light into the desorption chamber 14 in a manner which will irradiate powder material within the desorption chamber 14. A window 38 can be provided to maintain the seal of the desorption chamber 14 while introducing the ultraviolet light. The window 38 should be made of a material that is transmissive to the wavelength of ultraviolet light that is utilized. In one embodiment the window is MgF₂. It is alternatively possible to have the ultraviolet light source positioned entirely within the desorption chamber 14. A vacuum quick disconnect 42 can be used to secure the light source 30. A lamp retainer ring 44 can be provided as a seat for the light source 30 and the window 38.

Once powder is VUV treated a nitrogen cover can be maintained and the whole treatment device can be transferred to a nitrogen filled glove box where the powder can be removed. The process can be batch or continuous.

This invention can be embodied in other forms without departing from the spirit or essential attributes thereof, and accordingly, reference should be had to the following claims to determine the scope of the invention.

I claim:

1. A process for the removal of adsorbed water from the surface of powder materials, comprising the steps of:
flowing a heated gas over the powder, the temperature of the gas being below the cracking temperature of the water, the gas being inert with the powder;
applying to the powder an ultraviolet light at a wavelength that will pass through the gas, heat the adsorbed water and desorb it, and reflect from the powder, the ultraviolet light having a wavelength of between 10-185 nm; and
removing the desorbed water from the system with the flowing gas.

2. The process of claim 1, wherein the powder is at least one selected from the group consisting of ceramics and metals.

3. The process of claim 1, wherein the powder is a metal.

4. The process of claim 1, wherein the gas is at a temperature of less than 300° C.

5. The process of claim 1, wherein the gas is at a temperature of 100-300° C.

6. The process of claim 1, wherein the wavelength of the ultraviolet light is between 130-160 nm.

7. The process of claim 3, wherein the metal is titanium.

8. The process of claim 3, wherein the metal is at least one selected from the group consisting of titanium, iron, aluminum, copper, and mixtures thereof.

9. The process of claim 1, wherein the gas is an inert gas.

10. The process of claim 1, wherein the gas is N₂.

11. The process of claim 1, wherein the absolute pressure of the gas is greater than 100 torr.

12. A process for desorbing water from the surface of powdered metals, comprising the steps of:
flowing a heated gas over the powder, the temperature of the gas being below the cracking temperature of the water, the gas being inert with the powder;
applying to the powder an ultraviolet light at a wavelength that will pass through the gas, heat the adsorbed water and desorb it, and reflect from the powder, the ultraviolet light having a wavelength of between 10-185 nm; and
removing the water from the powder with the flowing gas.

13. An apparatus for the removal of adsorbed water from the surface of metal powders, comprising:
a hermetic desorption chamber;
a source for applying UV light having a wavelength of between 10-185 nm to a powder within the chamber;
an source of an inert gas, the inert gas being at a temperature of between 100-300° C., the source being connected to the gas inlet of the desorption chamber.

14. The apparatus of claim 13, further comprising a vacuum pump for maintaining the pressure within the desorption chamber to as low as 100 torr.

15. The apparatus of claim 13, wherein the desorption chamber comprises a gas inlet and a gas outlet.

16. The apparatus of claim 13, wherein the desorption chamber comprises a crucible for positioning the powder in the path of the UV light from the light source.

17. The apparatus of claim 13, wherein the chamber further comprises a window that is transmissive to the UV light.
